(19) United States
(12) Patent Application Publication
(10) Pub. No.: US 2009/0080707 A1
(43) Pub. Date: Mar. 26, 2009

(54) BIOMETRIC CAMERA AUTHENTICATION

(75) Inventor: GORAN DJURIC, TUCSON, AZ (US)

Correspondence Address: GORAN DJURIC, 1213 E KLEINDALE ROAD, TUCSON, AZ, 85719, US

(73) Assignee: Mr. GORAN DJURIC, TUCSON, AZ (US)

(21) Appl. No.: 11/858,751

(22) Filed: Sep. 20, 2007

(51) Int. Cl. G06K 9/00

(52) U.S. Cl. 382/115

(57) ABSTRACT

Biometric Camera Authentication pairs users and computer devices using mathematical representations of facial features. A device camera aquires a user image for processing. Authentication is acheived by mathematical comparison of aquired image to user image stored in device.

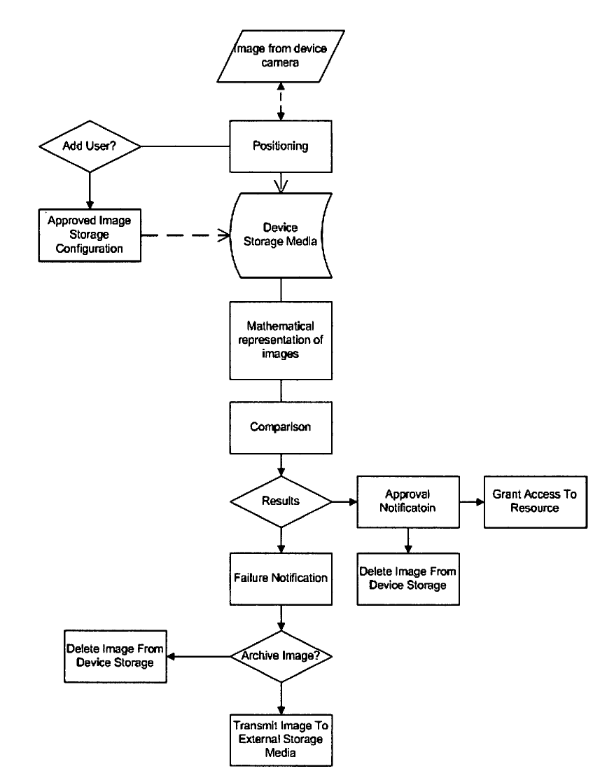

### FIELD OF THE INVENTION

The present invention relates to authentication methods for users to access their computers or mobile devices.

### BACKGROUND OF THE INVENTION

Technology users today can secure their computers or mobile devices by providing alphanumeric and non-alphanumeric characters for password authentication. Often these passwords must be changed regularly and comply with strong security standards. This puts adding burden on users to secure their devices. With passwords, breaches of security are often realized after the fact and often after the damage had been done. In current times many people use mobile phones of various types and secure them with the same character sequence confirmation methods commonly used. Since these devices are more often in the public domain, they are potentially even greater security risks.

Biometric Camera Authentication was developed to relieve users of password overhead while given them and their organizations strong methods to secure their information. Each of us has unique facial features that can be mathematically represented and compared to a high degree of certainty. With Biometric Camera Authentication, users will point their computer webcam, mobile device cameras or mobile phone camera at themselves and be authenticated without other input devices. Folders can individually be secured with biometric authentication, therefore placing a physical barrier between social engineering attacks or other security breaches and an individual's sensitive data.

### SUMMARY OF THE INVENTION

This invention provides authentication of computer or mobile devices by using face recognition techniques. Authentication is based on image processing and that a user physically is present.

In operations, users will point the cameras built into their devices and be guided into position for image acquisition. Once an image has been detected access will be granted or the user will be notified that authentication has failed.

### BRIEF DESCRIPTION OF DRAWINGS

Page 1 Shows how the data flows in the process. A user points a device attached camera at themselves sending the image to the positioning routine. Once an image is properly frame the user is notified and the image is stored as an authorized user and mathematically represented. This representation is then compared to any on the device's storage media and authentication is performed on the comparison. If authentication is successful, access is granted otherwise the image is archive and process according to user preferences.

What is claimed is:

1. A method of authenticating personal computer, or mobile device, users comprising the steps of:
a.) Capturing face image from said devices.
b.) Calculating a mathematical representation of said image.
c.) Storing representations, and images, of authorized users on device storage media.
d.) Comparing subsequent image representations with ones from memory stored on device media.
e.) Deciding if representations are highly similar.
f.) Granting access to device, or resources on its storage media and notifying user.
g.) Denying access to device, or resource on its storage media and notifying user while storage image on device storage or transferring it to other storage.

2. The method of capturing a face image comprises the steps of:
a.) User will point the device camera toward their face.

3. The method of claim 2 wherein obtaining self captured images will be done with the help of program that will guide user to correct camera setting and positioning and notify of successful image acquisition.
